(19) United States
(12) Patent Application Publication
(10) Pub. No.: US 2016/0173349 A1
(43) Pub. Date: Jun. 16, 2016

(54) SIMULATOR FOR TESTING A GATEWAY DEVICE

(71) Applicant: HCL Technologies Ltd., Noida (IN)

(72) Inventors: Tammana Uma Sankar, Noida (IN); Ankur Bansal, Noida (IN)

(21) Appl. No.: 14/957,506

(22) Filed: Dec. 2, 2015

(30) Foreign Application Priority Data
Dec. 10, 2014 (IN) 3641/DEL/2014

(51) Int. Cl. H04L 12/26; H04W 4/00; H04L 29/06

(52) U.S. Cl. CPC H04L 43/0811; H04L 69/03; H04L 65/1033; H04W 4/005

(57) ABSTRACT

System and method for testing a gateway device is disclosed. The system comprises a communication port and a memory coupled to one or more processors. The system is configured to identify a gateway device connected to the system through the communication port. The system further identifies a set of protocols applicable to the gateway device. Once the protocols are identified, the system simulates a network device to connect with the gateway device using a protocol from the set of protocols. The system further enables the network device to connect with the gateway device in order to determine a performance of the network device.

### CROSS-REFERENCE TO RELATED APPLICATIONS AND PRIORITY

The present application claims benefit from Indian Complete Patent Application No. 3641/DEL/2014, filed on Dec. 10, 2014, the entirety of which is hereby incorporated by reference.

### TECHNICAL FIELD

The present disclosure in general relates to the field testing. More particularly, the present disclosure relates to a system and method for load and integration testing of a gateway device.

### BACKGROUND

Nowadays with the growth in field of networking and Internet of things (IOT), Machine-To-Machine (M2M) gateway devices have gained a lot of importance. The gateway devices are used in different business sectors like Industrial, Home, Medical and the like. These gateway devices enable controlling different network devices (electronic devices and electronic sensors) connected over a communication network. However, due to increase in demand of gateway devices there are multiple Original Equipment Manufacturers (OEMs) manufacturing the gateway devices and different solutions providers are developing software stacks for configuration and deployment of gateway devices. The software stack generally contains different software components like service layer, core, device connectivity, event action, alarm management and the like for configuring and deploying of gateway devices.

In the deployment process, configuring the device connectivity layer of the gateway is a time consuming process as it requires understanding the gateway devices and its supported features. Further, using physical network devices for testing the gateway device connectivity layer involves a considerable amount of setup time for these network devices. Even if implementation of other modules complete earlier, integration testing with device connectivity layer cannot be completed without the network devices, thus delaying the discovery of integration issues.

All These factors lead to increase in the configuration and deployment time. After software stack implementation, to run the load test by connecting multiple network devices requires procurement of many network devices which increases the cost of product. Also, a gateway device can support connecting multiple types of network devices like ZigBee, BT, etc. at the same time. Thus, there is a need to develop a solution for testing gateway devices in a better and efficient manner.

### SUMMARY

This summary is provided to introduce aspects related to systems and methods for testing a gateway device and the aspects are further described below in the detailed description. This summary is not intended to identify essential features of the claimed subject matter nor is it intended for use in determining or limiting the scope of the claimed subject matter.

In one implementation, a method for testing a gateway device is disclosed. Initially, the gateway device connected to a communication port is identified. In the next step, a set of protocols applicable to the gateway device are identified. Based on the set of protocols identified, a network device to be connected with the gateway device based on a protocol from the set of protocols is simulated. Further, the simulated network device is connected to the gateway device in order to determine a performance of the network device.

In one implementation, a system for testing a gateway device is disclosed. The system comprises of a communication port and a memory coupled to one or more processors or other systems. Further, the system is configured to identify the gateway device connected to the system through the communication port. The system further identifies a set of protocols applicable to the gateway device. Further, the system is enabled to simulate a network device to connect with the gateway device based on a protocol from the set of protocols. The system further enables the simulated network device to connect with the gateway device in order to determine a performance of the network device.

In one implementation, a computer program product having embodied thereon a computer program for testing a gateway device is disclosed. The program comprises a program code for identifying the gateway device connected to the system through a communication port. The program comprises a program code for identifying a set of protocols applicable to the gateway device. The program further comprises a program code for simulating a network device to connect with the gateway device based on a protocol from the set of protocols. The program further comprises a program code for enabling the simulated network device to connect with the gateway device in order to determine a performance of the network device.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like/similar features and components.

FIG. 1 illustrates a network implementation of a system for testing a gateway device is disclosed, in accordance with an embodiment of the present disclosure,

FIG. 2 illustrates the system for testing the gateway device, in accordance with an embodiment of the present disclosure.

FIGS. 3a-3d illustrate different implementation scenarios of the system for testing the gateway device, in accordance with an embodiment of the present disclosure.

FIG. 4 illustrate a flowchart representing a method for testing the gateway device is disclosed, in accordance with an embodiment of the present disclosure.

FIG. 5 illustrates a process of simulating a network device for testing the gateway device, in accordance with an embodiment of the present disclosure.

### DETAILED DESCRIPTION

The present disclosure relates to systems and methods for testing a gateway device. In one implementation, the system is configured to reduce time and cost for testing and implementation of the gateway device. The system supports multiple connectivity interfaces to connect with different types of gateway devices. Further, the system is configured to simulate different network devices, wherein each of the network devices is configured for implementation and testing of the gateway device.

While aspects of described system and method for implementation and testing of gateway devices may be implemented in any number of different computing systems, environments, and/or configurations, the embodiments are described in the context of the following exemplary system.

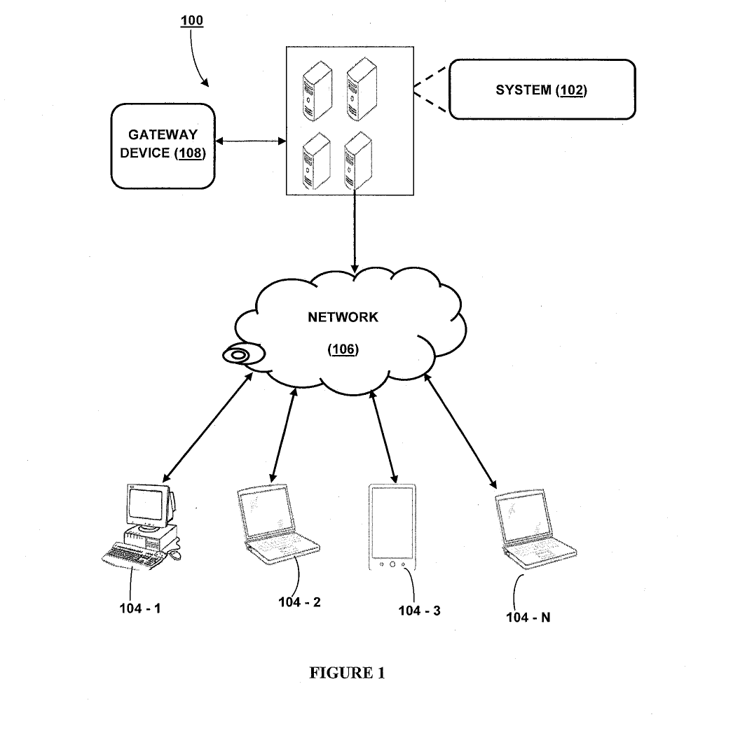

Referring now to FIG. 1, a network implementation 100 of a distributed device simulator system hereafter referred to as a system 102 for testing a gateway device 108 is illustrated, in accordance with an embodiment of the present disclosure. In one embodiment, the gateway device 108 may be a Machine-to-Machine (M2M) gateway device. Although the present disclosure is explained by considering that the system 102 is implemented as a software program on a server, it may be understood that the system 102 may also be implemented in a variety of computing systems, such as a laptop computer, a desktop computer, a notebook, a workstation, a mainframe computer, a server, a network server, cloud, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a hand-held device, and a workstation. The user devices 104 are communicatively coupled to the system 102 through a network 106. Further the system 102 is also connected to a gateway device 108 through a communication port.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

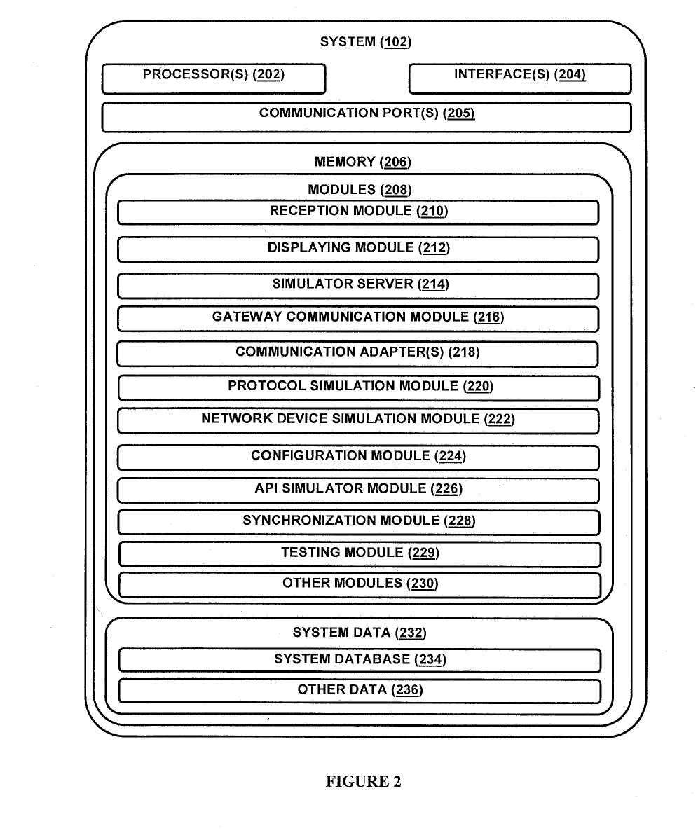

Referring now to FIG. 2, the system 102 is illustrated in accordance with an embodiment of the present disclosure. In one embodiment, the system 102 may include at least one processor 202, an input/output (I/O) interface 204, a communication port 205, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and system data 230.

The modules 208 include routines, programs, objects, components, data structures, etc., which perform particular tasks or implement particular abstract data types. In one implementation, the modules 208 may include a reception module 210, a displaying module 212, a simulator server 214, a gateway communication module 216, communication adapter(s) 218, a protocol simulation module 220, a network device simulation module 222, a configuration module 224, an API (application programming interface) simulation module 226, a simulation synchronization module 228, a testing module 229, and other modules 230. The other modules 230 may include programs or coded instructions that supplement applications and functions of the system 102.

The system data 232, amongst other things, serves as a repository for storing data processed, received, and generated by one or more of the modules 208. The system data 232 may also include a system database 234 and other data 236. The other data 236 may include data generated as a result of the execution of one or more modules in the other modules 230.

In one implementation, the multiple users may use the client devices 104 to access the system 102 via the I/O interface 204. In one embodiment, the system 102 may employ the reception module 210 to receive instructions for testing the gateway device 108 from user devices 104. In one embodiment the user devices 104 may be a platform for testing the gateway device 108.

Further, the system 102 is enabled to detect the gateway device 108 connected to the system 102 through the communication ports 205, based on the request received by a simulator client running on the system 102. In one embodiment, the simulator client is implemented on gateway device 108. The simulator client acts as an interface between modules present in the gateway device 108 and system 102. The communication between gateway device 108 and the Simulator Client is enabled through Inter-Process Communication (IPC). Further, the Simulator Client is enabled to stores the configuration settings to connect with the system 102. This Simulator Client also maintains the configuration for connecting the system 102 with modules in the gateway device 108. While initializing the Gateway device 108, the simulator client creates single or multiple instances based on the configuration associated therewith.

The role of this simulator client is to:
a. Initialize the physical connection with system 102 and IPC for other modules in the gateway device 108 based on configuration information.
b. Receive the asynchronous requests from the other gateway devices 108 connected to the system 102 and processing the requests based on the configuration.
c. Receive the responses from system 102 and send back the responses to the requester (other M2M Gateway modules) via IPC.
d. Receive the asynchronous device events from the system 102 and forward the events to modules of the gateway device 108 that can process the events.

Alternately, the gateway device 108 may directly communicate to the system 102. Once the system 102 detects the gateway device 108 connected through the communication port 105, the simulator server 214 in the system 102 processes the requests coming from gateway device 108 via the simulator client, and posts back acknowledgment responses. Further, the simulator server 214 sends asynchronous event to gateway device 108. In the next step, the gateway communication module 216 establishes a physical connection between Simulator server 214 and gateway device 108. In one embodiment, the gateway device 108 may support multiple connection protocols like TCP/IP, Serial protocols (RS48, RS232, etc.). The gateway communication module 216 is configured to detect the set of protocols that are supported by the gateway device 108. Based on the set of protocols associated with the gateway device 108, multiple interfaces can be connected to the system 102 through the simulator server 214 at the same time. The support for communication between gateway device 108 and system 102 through multiple protocols is achieved using the Communication Adaptors 218. For each communication protocol there is a corresponding adapter associated therewith. For instance in order to support a TCP/IP protocol and a RS-485 protocol, the system 102 enables a TCP communication adaptor and a RS-485 communication adaptor respectively. In one embodiment the support for communication through newly developed protocols may be generated by including new adaptors for the newly developed protocols.

Further, the protocol simulation module 220 is enabled to parse the request received from the gateway device 108. In the next step, the protocol simulation module 220 composes packets comprising requests, responses and events to be sent to the gateway device 108 based on the received request form the gateway device 108. These packets are composed based on the designated protocol standards. The protocol simulation module 220 is enabled to support multiple protocols including open standard protocols like ZigBee, Modbus, Backent, and Profibus as well as proprietary protocols. For the proprietary protocols, customization is enabled by the protocol simulation module 220 where gateway device 108 follow non-standard or device specific or OEM specific standards and the packets are generated accordingly.

Further, the network device simulation module 222 controls objects that represent simulated network devices and its properties. The network device simulation module 222 may receive request from the user through the interface 204 to control a particular network device. Based on the request, network device simulation module 222 may either change the state of the network device or send failure response to the gateway device 108. The network device simulation module 222 may also generate events based on the type of the network device and send the event to gateway device 108. The network device simulation module 222 is enabled to create multiple objects based on simulation requirements specified by the user. Each of the simulated network devices has a Globally Unique Identifier (GID) to distinguish it from other network devices. The runtime information of the simulated network devices may also be stored in the system database 234. Further, the system database 234 is also configured to maintain a repository for storing a set of protocols associated with the gateway devices 108. The repository is also configured to store configuration settings, a set of controls, and a connectivity type associated with the network devices 108.

Further, the configuration module 224 maintains information about how the system 102 is to be connected to the gateway device 108. Further, the configuration module 224 also maintains information about the network devices that are to be simulated for testing the gateway device 108. This configuration information is stored in the system database 234. In one embodiment, the system 102 may be configured by the configuration module 224 using various methods like GUI (Graphical User Interface), CLI (command line interface), APIs associated with the system 102, or by manually updating the system database 234.

Further, the system database 234 is configured to stores information such as the list of network devices, configurations and control information associated therewith. This configuration information may include, but is not limited to current state of the network devices, a set of protocols supported by the network device, and connectivity type with gateway devices 108. The configuration information is loaded from the system database 234 during initialization of the system 102. The configuration and control information for simulating the network devices may be stored in the system database 234 in tables 1 to 4 as given below, with sample values:

TABLE 1
Network Device Type, GID and Protocol Map Table

| | Network Device Simulate | |
|---|---|---|
| GID | Protocol | Network Device |
| 1 | ZigBee | Light |
| 2 | BT | Oximeter |
| 3 | TCP/IP | Camera |

TABLE 2
Network Device Configuration Table

| | | | | | |
|---|---|---|---|---|---|
| GID | Param-1 | Param-2 | Param-3 | . . . | Param-n |

| | | | |
|---|---|---|---|
| 1 | EUI64 address | End point ID | |
| 2 | MAC Address | IP Address | Port |
| 3 | IP address | Port no | |

TABLE 3
Network Device Status Table

| | | | | | |
|---|---|---|---|---|---|
| GID | Param-1 | Param-2 | Param-3 | . . . | Param-n |

| | | |
|---|---|---|
| 1 | Light On | |
| 2 | Heartbeat - 90 | Oxygen saturation |
| | | 90% |
| 3 | Motion Event | |

TABLE 4
Network Device type protocols and Physical
Connection type protocol Map Table

| Simulated network Device | |
|---|---|
| type protocol | Physical Connection Protocol |
| ZigBee | Serial - RS-232 (Port1, baud rate, flags) |
| IP Camera | TCP/IP (Gateway IP, Port, etc.) |
| BT | Serial - RS-485 (Port2, baud rate, flags) |

In one embodiment, the I/O interface 204 of the system 102 includes a Graphical User Interface (GUI), and a Command Line Interface (CLI), for interacting with the system 102. The I/O interface 204 allows the user to configure the network devices and display the status of the each network device which is configured and also present runtime changes that are controlled by Gateway device 108. User can also set the status for network devices which may optionally internally generate events for the same. In addition to the I/O interface 204, the system 102 enables the API simulator module 226. The API simulator module 226 provides an APIs (Application Programming Interface), to allow configuring and controlling the system 102 programmatically, from other software's.

Once the gateway device 108 is configured as per the configuration settings specified by the user, the gateway testing module 229 is enabled to test the gateway device 108. For this purpose, the gateway testing module 229 may simulate multiple instances of the same network device in order to test the gateway device 108 for load testing. Further, the gateway device 108 may also simulate network devices for all combinations of protocols that are applicable to the gateway device 108 and test the connectivity for each combination of network devices for the purpose of integration testing.

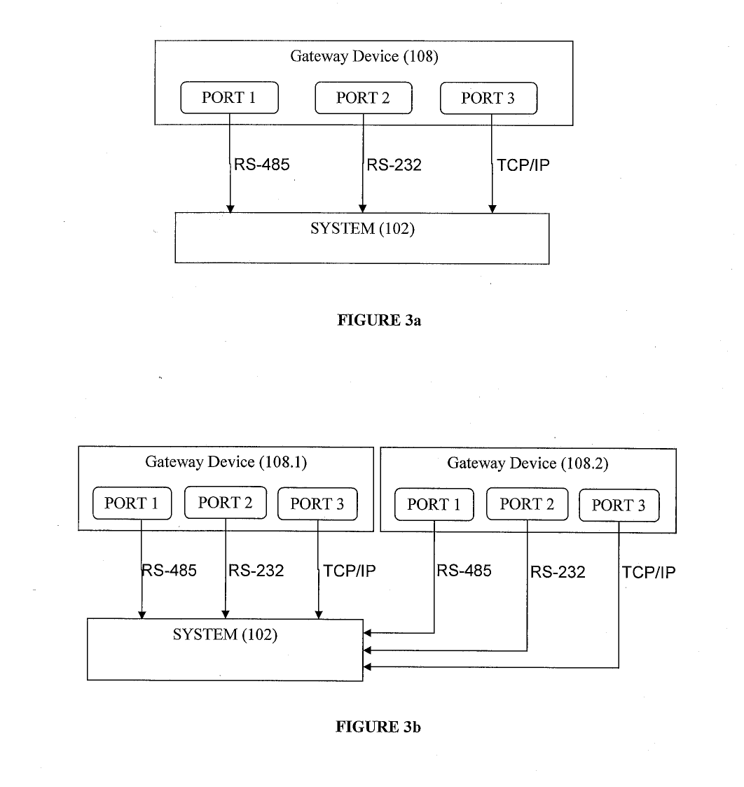

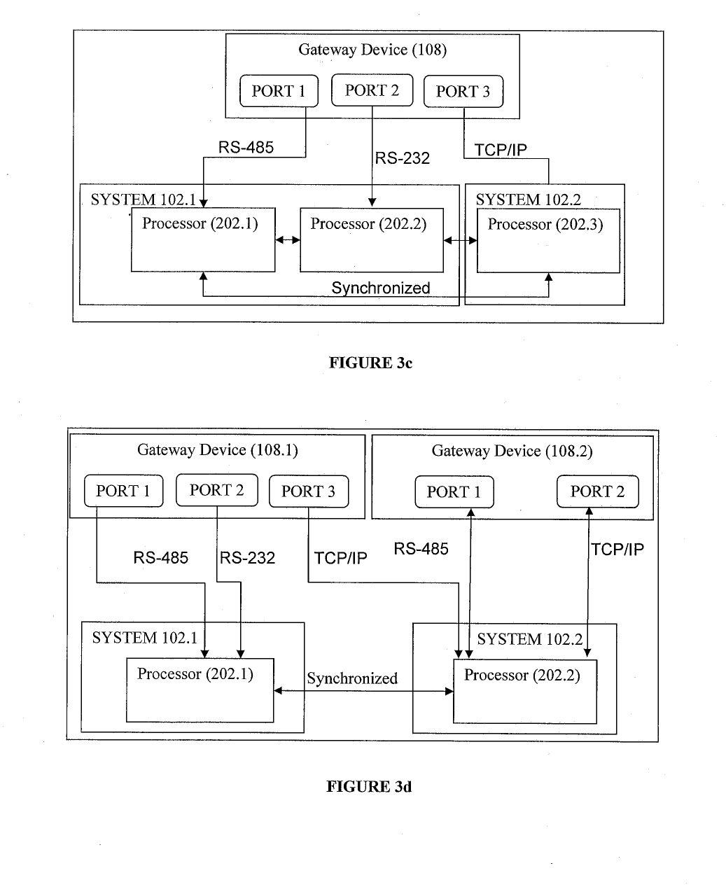

In one embodiment, the system 102 may be implemented in a distributed computing environment using more than one processor's 202. The synchronization module 228 enables synchronization of the system 102 running on multiple processors 102. Further, the information like, configurations, device database, simulated network device status, overall health status of the simulated network devices etc., is synchronized as and when required, by the synchronization module 228. Further, the system 102 may be implemented over a standalone mode, where the system 102 is implemented over a single processor when low processing power is required. The different implementation scenarios for implementing the system 102 in standalone mode as well as distributed environment are covered in the FIG. 3a-3d.

In one embodiment, as disclosed in FIG. 3a, the system 102 may be connected to a single gateway device 108. The system 102 may receive request to control the network devices from the gateway device 108. The request contains information associated with network device protocol type and physical connection associated with the gateway device 108. Further, the gateway device 108 is enabled to connect with the network devices simulated by the system 102 such as ZigBee Device, BT & IP Camera through the Ports 1, 2 & 3 respectively. The system 102 is enabled to receive BT device controlling commands from Gateway device 108 from the gateway device 108 through Serial connection RS-485. Further, the system 102 is enabled to receive ZigBee device controlling commands from Gateway device 108 through Serial connection RS-232. Further, the system 102 is enabled to receive Camera device controlling commands from the gateway device 108 through TCP-IP.

In one embodiment, as disclosed in FIG. 3b, the system 102 may be connected to more than one gateway device 108. For instance, the system 102 may be connected to a gateway device 108.1 and a gateway device 108.2. The system 102 may receive requests from both the gateway devices 108.1 and 108.2 to control the network devices. This request may contain network device protocol type and physical connection associated with the gateway devices 108.1 and 108.2 respectively. The system 102 is enabled to receive requests from both gateway devices 108.1 and 108.2 to connect with network devices such as ZigBee Device, BT & IP Camera simulated by the system 102. The request may be received through the Ports 1, 2 & 3 associated with each of the gateway devices 108.1 and 108.2. Further, the gateway devices 108.1 and 108.2 are enabled to send BT device controlling commands from Gateway devices 108.1 and 108.2 to the system 102 through Serial connection RS-485. Further, the gateway devices 108.1 and 108.2 are enabled to send ZigBee device controlling commands from Gateway devices 108.1 and 108.2 to system 102 through Serial connection RS-232. Furthermore, the gateway devices 108.1 and 108.2 are enabled to send Camera device controlling commands from gateway devices 108.1 and 108.2 to system 102 through TCP-IP protocol.

In one embodiment, as disclosed in FIG. 3c, the system 102 may have a distributed architecture with more than one processor 202 distributed across more than one systems 102 for faster processing and simulation of network devices. In one example the system 102.1 may be enabled with processor 202.1, processor 202.2 and system 102.2 may be enabled with the processor 202.3. The system 102.1 may receive request from the gateway device 108 through port 1 and port 2 to control the network devices simulated by the system 102.1 and system 102.2 may receive request from the gateway device 108 through port 3 to control the network devices simulated by the system 102.2. The request contains information associated with network device protocol type and physical connection associated with the gateway device 108. Further, the gateway device 108 is enabled to connect with network devices such as ZigBee Device, BT & IP Camera simulated by the system 102 through the connected to Ports 1, 2 & 3 associated with the gateway device 108. For the purpose of distributed processing, the processor 202.1 of system 102.1 is enabled to handle BT device controlling commands received by the system 102.1 from the gateway device 108 through Serial connection RS-485, the processor 202.2 is enabled to handle ZigBee device controlling commands received by the system 102.1 from Gateway device 108 through Serial connection RS-232, and processor 202.3 of system 202.2 is enabled to handle Camera device controlling commands received by the system 102.2 from Gateway device 108 through TCP-IP. The processors 202.1, 202.2 and 202.3 are synchronized by the synchronization module 228 of the systems 102.1 and 102.2 for the purpose of distributed processing.

In one embodiment, as disclosed in FIG. 3d, the system 102 may have a distributed architecture with more than one processor(s) 202 connected with more than one gateway devices 108 for faster processing and simulation of network devices for testing the gateway devices 108. In one example the system 102.1 may be enabled with processor 202.1 and the system 102.2 may be enabled with processor 202.2, wherein the processors 202.1 and 202.2 are synchronized together by the synchronization module 228. Further, gateway devices 108.1 and 108.2 may be connected to the system 102.1 and system 102.2. In one embodiment, the processor 202.1 is enabled to simulate network devices associated with RS-485 and RS232 protocols. Further, the processors 202.2 is enabled to simulate network devices associated with RS-485 and TCP/IP protocols. As disclosed in FIG. 3d, the gateway device 108.1 is connected to processor 202.1 of the system 102.1 through the port 1 and port 2 of the gateway device 108.1 through RS-485 and RS-232 communication. Further, the gateway device 108.1 is also connected to the processor 202.2 of the system 102.2 through port 3 of the gateway device 108.1 through TCP/IP. Further, ports 1 and port 2 of the gateway device 108.2 are connected to the processor 202.2 of the system 102.2 through RS-485 and RS-232 protocols.

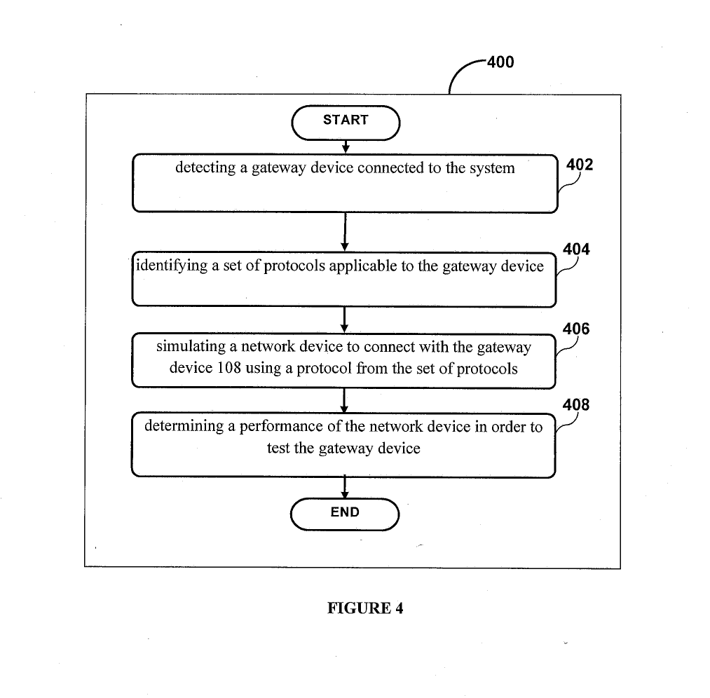

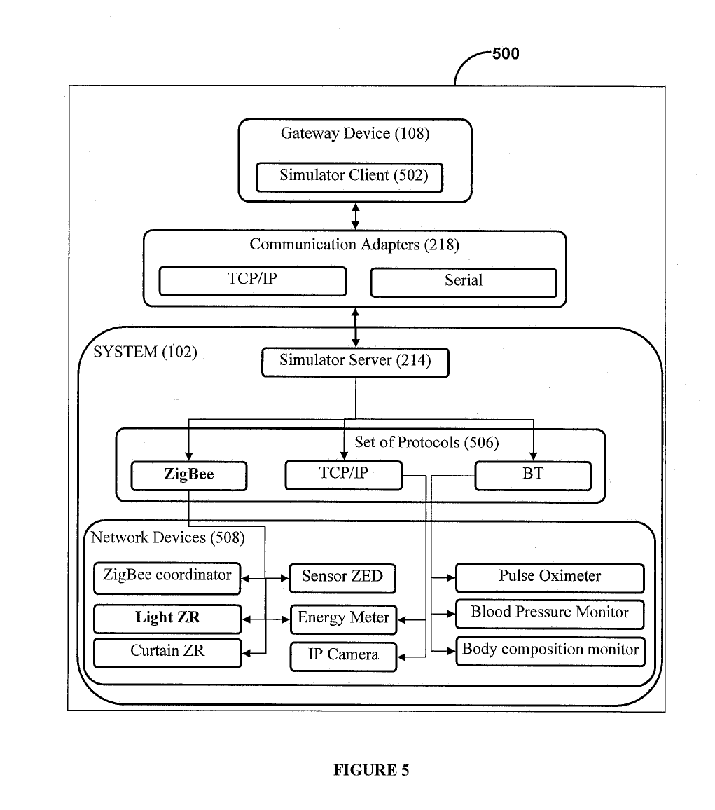

Once the communication between the system 102 and the gateway device 108 is established, the testing of the gateway device 108 is initiated. The process of testing the gateway device 108 is classified into four major steps namely a) detecting the gateway device 108 connected to the system 102, b) identifying a set of protocols applicable to the gateway device 108, c) simulating a network device to connect with the gateway device 108 using a protocol from the set of protocols, and d) determining a performance of the network device in order to test the gateway device 108. These four steps are explained in detail with respect to FIG. 4.

FIG. 4 discloses a flow chart for testing the gateway device 108 based on the network devices simulated by the system 102. At step 402, the system 102 detects a gateway device 108 connected to the system 102. In one embodiment more than one gateway devices 108 may be connected to the system 102 at the same time. Further, the system 102 may have a distributed architecture based on different implementation scenarios as disclosed in FIG. 3a-3d. In order to detect the gateway device 108, the simulator server 214 processes the requests coming from simulator client of the gateway device 108, and posts back the responses confirming the establishment of the communication.

At step 404, a set of protocols applicable to the gateway device 108 are identified by the system 102. In one embodiment, gateway communication module 216 is configured to detect the set of protocols that are supported by the gateway device 108. Based on the set of protocols associated with the gateway device 108, multiple interfaces can be connected at the same time to the system 102 through the simulator server 214. The support for communication through multiple protocols is achieved using Communication Adaptors 218. For each protocol from the set of protocols, there is a corresponding adapter associated therewith. For instance in order to support a TCP/IP protocol and a RS485 protocol, the system 102 enables a TCP communication adaptor and a RS485 communication adaptor respectively.

At step 406, at least one network device to connect with the gateway device 108 using a protocol from the set of protocols is simulated by the system 102. In one embodiment, the Network Device Simulation Module 222 contains objects that represent simulated network devices and its properties. The Network Device Simulation Module 222 may receive request from the user using the interface 204 to control the network device. Based on the request Network Device Simulation Module 222 may either change the state of the network device or send failure response to the gateway device 108. The Network Device Simulation Module 222 may also generate events based on the network device type and send it to gateway device 108. The Network Device Simulation Module 222 is enabled to create multiple objects based on simulation requirements specified by the user. Each of the simulated network devices has a Globally Unique Identifier (GID) to distinguish it from other network devices.

Once the network devices are simulated, at step 408, the system 102 enables testing of the gateway device 108 based on the at least one network device simulated by the network device simulation module 222. In one embodiment, the testing module 229 is implemented in order to perform load test of the gateway device 108. For this purpose, the testing module 229 may simulate multiple instances of the same network device for load testing. In one embodiment, more than one processor's 202 are enabled to generate multiple instances of the network device for testing connectivity of the gateway device 108 and determine the performance of the gateway device 108. In one embodiment, multiple gateways 108 may be connected to system 102 and standard testing tools may be used for the purpose of load testing. The standard testing tool is enabled to send different requests through the gateway devices 108 for accessing the virtual devices enabled on the system 102. The response received from the system 102 is monitored by the standard testing tool for the purpose of load testing.

Further, the gateway device 108 may also simulate network devices for all combinations of protocols that are applicable to the gateway device 108 and test the connectivity for each combination of network devices for the purpose of integration testing. The Integration testing is initiated once the basic framework and connectivity between the system 102 and the gateway device 108 is completed. Further, integration testing may be used for testing functionalities like incremental integration and find the issues in early stage. The Integration testing and load testing may be performed either using manual testing or automation testing tools like Jmeter™, Testbed™, Jira™ etc.

FIG. 5 discloses the process 500 for testing the gateway device 108 using the system 102. Initially, the gateway device 108 sends a request to access at least one network device from the network devices 508, wherein the network devices are simulated by the system 102. For this purpose, the software module in gateway device 108 sends a device control command (Ex: protocol: ZigBee, Network Device: Light-1, device status: On) to a Simulator client 502 present inside gateway device 108, through the IPC. On receiving the control command, the Simulator Client 502 forwards the control command to Simulator Server 214 of the system 102. The control command is forwarded to the simulator server 214 through the communication adapter 218. In this example the control command is forwarded to Simulator Server 214 through RS-232 connection.

Further, on receiving the control command, System 102 performs the steps of:
a. Getting “Device Simulated protocol” and “Network Device Type” from the Device GID and Protocol Map Table.
b. Parsing the control command to identify the protocol (i.e. Protocol: Zigbee) form a set of protocols 506 stored in the system database 234 of the system 102.
c. Parsing the control command to identify the network device type (i.e. network device type: Light ZR) from the network device 508 simulated by the system 102.
d. Updating the network device status based on the “control command” in the Device Status Table (i.e. status: On).
e. Compose the response based on the network device type and identified network device protocol.

Further, a signal indicating updated network device status (Light-1: On) is conveyed to the user through the I/O interface 204. Once the device status is updated, a response is sent back to Simulator Client 502 via physical connection established based on the identified protocol. On receiving the response, the Simulator client 502 forwards the response back to modules in the gateway device 108 via configured IPC.

Further, in order to test the gateway device 108 from the system 102, an asynchronous network device event may be transmitted from the system 102 to the gateway device. For this purpose, the user may select a network device and change its status from the I/O interface 204. For example, the user may instruct the system 102 to trigger monitoring through camera-1 (GID-3). For this purpose, the system 102 may perform the steps of:
1. Get “network Device Simulated protocol” and “network Device Type” from the Device GID and Protocol Map Table for Camera-1 GID.
2. Compose an event based on the network device type and protocol associated therewith
3. Send the asynchronous event to Simulator Client 502 via physical connection established between the system 102 and the gateway device 108 based on the protocol associated with simulated network device. The asynchronous events can be generated by the user using CLI (Command Line Interface) or GUI (Graphical User Interface). The asynchronous events may be Intrusion/Motion detection, Fire detection, etc. The gateway device 108 is enabled to handle corresponding functionalities (rules) mapped to these asynchronous events.

On receiving the asynchronous event, the Simulator client 502 forwards the asynchronous event to other Gateway modules via configured IPC.

Although the present disclosure relates to implementation of system and method for predicting performance of a gateway device 108, it is to be understood that the appended claims are not necessarily limited to the specific features or methods described herein. However, the specific features and methods are disclosed as examples of implementations for testing the gateway device.

What is claimed is:

1. A system for testing a gateway device, the system comprising:
a memory;
a communication port; and
one or more processors coupled to the memory and to the communication port, wherein the one or more processors are configured to perform the steps of:
detecting a gateway device connected to the communication port;
identifying a set of protocols applicable to the gateway device;
simulating a network device to connect with the gateway device using a protocol from the set of protocols; and
determining a performance of the network device in order to test the gateway device.

2. The system of claim 1, wherein the gateway device is a Machine To Machine (M2M) gateway device.

3. The system of claim 1, further comprising a repository to store the set of protocols associated with the gateway device.

4. The system of claim 3, wherein the set of protocols applicable to the gateway device is identified from the repository.

5. The system of claim 3, wherein the repository is further configured to store configuration settings, a set of controls, and a connectivity type associated with the network device.

6. The system of claim 1, wherein the one or more processors are distributed in a distributed computing environment.

7. The system of claim 1, wherein the one or more processors further generate multiple instances of the network device for testing connectivity of the gateway device and determine the performance of the gateway device.

8. A method for testing a gateway device, the method comprising steps of:
detecting, by one or more processors, a gateway device connected to a communication port;
identifying, by the one or more processors, a set of protocols applicable to the gateway device;
simulating, by the one or more processors, a network device to connect with the gateway device using a protocol from the set of protocols; and
determining, by the one or more processors, a performance of the network device in order to test the gateway device.

9. The method of claim 8, wherein the gateway device is a Machine To Machine (M2M) gateway device.

10. The method of claim 8, further comprising a repository to store the set of protocols associated with the gateway device.

11. The method of claim 10, wherein the set of protocols applicable to the gateway device is identified from the repository.

12. The method of claim 10, wherein the repository is further configured to store configuration settings, a set of controls, and a connectivity type associated with the network device.

13. The method of claim 8, wherein the one or more processors are distributed in a distributed computing environment.

14. The method of claim 8, wherein the one or more processors further generate multiple instances of the network device for testing connectivity of the gateway device and determine the performance of the gateway device.

15. A computer program product having embodied thereon a computer program for testing a gateway device, the computer program product comprising:
a program code for detecting a gateway device connected to a communication port;
a program code for identifying a set of protocols applicable to the gateway device;
a program code for simulating a network device to connect with the gateway device using a protocol from the set of protocols; and
a program code for determining a performance of the network device in order to test the gateway device.
